(19) United States
(12) Patent Application Publication
(10) Pub. No.: US 2009/0307314 A1
(43) Pub. Date: Dec. 10, 2009

(54) MUSICAL INTEREST SPECIFIC DATING AND SOCIAL NETWORKING PROCESS

(76) Inventors: Patrick Martin Luther Smith, Salem, OR (US); Rod Underhill, Julian, CA (US)

Correspondence Address: KLARQUIST SPARKMAN, LLP, 121 SW SALMON STREET, SUITE 1600, PORTLAND, OR, 97204, US

(21) Appl. No.: 12/134,015

(22) Filed: Jun. 5, 2008

(51) Int. Cl. G06F 17/30; G06F 15/16

(52) U.S. Cl. 709/206; 707/100; 707/E17.009

(57) ABSTRACT

A method for determining dating compatibility of users of an online system based on music interests includes obtaining music preferences of users by ranking different genres of music according to the desirability of those genres of music to the first user and comparing the music preferences of the users to provide users with potential matches.

### FIELD

This invention relates generally to the field of dating and social networking, and more particularly, to a method and system of matching individuals based on their music interests and preferences.

### BACKGROUND

Music has long been a source of community connections, and people who enjoy and listen to the same types and kinds of music often have similarities of personality that extend well beyond their interest in music.

The internet has spawned many different sites that provide users with some capability of locating and meeting people who share their similar interests in music. For example, www.myspace.com is a popular social networking site that permits users to join different “groups” or “networks” based on a variety of topics and interests, including music. These groups or networks are generally devoted to one specific artist or genre. Thus, the only musical “matching” that occurs with the use of these groups is a self-indicated appreciation of that one artist or genre.

In addition to joining music specific groups, users of social networking sites such as www.myspace.com can usually perform keyword searches to try to locate other users that may have similar interests in music. Similarly, online dating systems often permit some limited ability to search profiles for various keywords, including those relating to music. Using this method, a user can attempt to locate other individuals on the system who may share the same or similar interests in music.

Such keyword searching, however, has many shortcomings when it comes to trying to match people based on their musical interests. First, there is no guarantee that individuals will even include their musical interests in their user profile. In other words, although one user may have the exact same musical interests as another, he or she may not have included that information in their profile. In such a situation, keyword searching for musical artists or genres would be ineffective. Second, there is no way to search for users that share a broader range of interests since searching must generally be performed using only one or two keywords at a time. Thus, while it may be possible to locate someone who likes a musician or band that you like, it is not possible to perform a keyword search to locate someone who has the same range or complexity of interests as the searcher. Third, some individuals may list in their profile musicians that do not accurately reflect their interests. The mere fact that the musician's name is listed in a profile does not mean that the user likes that artist. Moreover, keyword searching cannot generally discriminate between negative and positive uses of a musician's name in a profile. Fourth, to the extent that other users have introduced spelling errors, abbreviations, or other shorthand identifiers in their profile, those users may not be reflected in the results of a specific keyword search.

Accordingly, the ability to find and connect with others that may share similar interests in music is currently limited to either joining musician specific groups or networks, or performing simple keyword searches. Thus, there is a need for a musical interest specific dating and social networking site that permits users to locate and meet individuals with the same or similar musical tastes.

### SUMMARY

According to one embodiment, a method for determining dating compatibility of users of an online network based on music interests is provided. The method includes creating a first profile of a first user of the network, and creating a plurality of other profiles for a plurality of other users of the network. A music preference of the first user is obtained by ranking at least five different genres of music according to the desirability of those genres of music to the first user. Music preferences of other users are obtained by ranking the five different genres of music according to the desirability of those genres of music to each of the plurality of other users. The music preferences of the first user is compared to the music preferences of the plurality of other users to determine a musical compatibility between the first user and the plurality of other users. The musical compatibility is based on the similarity of the rankings of the five different genres of music. The plurality of other users are sorted in order of a most compatible match to a least compatible match. The first user is provided with a list of potential matches. The list includes at least the most compatible match.

In one aspect, the music preference of the first user and the music preferences of the plurality of other users are obtained by ranking at least ten different genres of music according to the desirability of those genres of music to each user.

In another aspect, the steps of obtaining the music preference of the first user and obtaining the music preferences of the plurality of other users includes the following steps. The first user and the other users are presented with a list of genres to be ranked, with the list including the five different genres of music. The first user and the other users are permitted to rank the genres in the list by dragging-and-dropping the genres on a display screen until the order of the list reflects the order of desirability of those genres to the first user and each of the plurality of users.

In another aspect, a digital music collection of the first user and each of the plurality of other users is analyzed to determine the music preferences of the first user and the other users. The digital music collections can be stored on digital storage mediums. At least some of the music contained in each of the digital music collections can be categorized into the five different genres of music, and the music preferences of the first user and other users can be determined by ranking the five different genres of music in order of a most highly represented genre to a least highly represented genre.

In another aspect, the highest ranked genre of music by the first user and each of the plurality of other users is identified and a list of at least five sub-genres is created for the highest ranked genre of music. The sub-genres are types of music that are encompassed by the highest ranked genre of music. A sub-genre music preference is obtained for first user and the other users by ranking the five different sub-genres according to the desirability of those sub-genres to the first user and the other users, respectively. The music preferences of the first user is further compared to the music preferences of the plurality of other users based on the rankings of the five different sub-genres of music to further determine the musical compatibility between the first user and the plurality of other users. The plurality of other users are further sorted in order of a most compatible match to a least compatible match based on the further comparing step.

In another aspect, at least one deal-breaking genre of the first user is obtained. The deal-breaking genre is one of the five different genres of music and is identified by the first user to reflect a subjective dislike for that particular genre of music. The deal-breaking genre of the first user is compared to the music preferences of the plurality of other users, and the musical compatibility of the first user to each of the plurality of other users that ranked the deal-breaking genre in their top two most desirably genres is reduced.

In another aspect, dating filtering information of the first user and the plurality of other users is obtained. The dating filtering information includes the sex, age, and geographic location of the first user and each of the plurality of other users. The plurality of other users are further sorted in order of a most compatible match to a least compatible match based on the dating filtering information.

In another aspect, the first user is provided with access to the profiles of the potential matches. The profiles of the potential matches can be provided to the first user using hyperlinks that direct the first user to the profiles of the potential matches. In addition, the first user can be provided with the ability to send an electronic message to each of the potential matches.

In another aspect, the first user can be provided with the ability to send a gift of music to each of the potential matches. The gift can comprise a mixtape, the mixtape being a compilation of songs selected by the first user, with the sequence of the songs being selected by the first user. The mixtape can be sent to the other users identified on the listing as one or more downloadable, digital files. Alternatively, the mixtape can be sent to the other users identified on the listing via the mail as a compact disc. If the mixtape is sent as a compact disc, the first user can select one or more images that can be included on the packaging of the compact disc.

In another aspect, the gift can comprise a pre-selected album or song that was pre-selected by the potential match and that is unknown to the first user. In addition, the identity of the pre-selected album or song can be taken into consideration in determining the musical compatibility between the first user and the potential match.

In another embodiment, a method for determining dating compatibility of users of an online network based on music interests is provided. The method includes obtaining a music preference of the first user by ranking at least five different genres of music according to the desirability of those genres of music to the first user, and obtaining the music preferences of the plurality of other users by ranking the five different genres of music according to the desirability of those genres of music to each of the plurality of other users. The music preferences of the first user are compared to the music preferences of the plurality of other users to determine a musical compatibility between the first user and the plurality of other users. The musical compatibility is based on the similarity of the rankings of the five different genres of music. The plurality of other users are sorted in order of a most compatible match to a least compatible match. The first user is sent a list of potential matches, with the list including at least the most compatible match. The first user is provided with the option of sending a mixtape to one or more of the potential matches identified in the list, with the mixtape being a compilation of songs presented in a specific order.

In one aspect, the mixtape can be sent to the other users identified on the listing as one or more downloadable, digital files. In another aspect, the mixtape can be sent to the other users identified on the listing via the mail as a compact disc. In addition, if the mixtape is a compact disc, the first user can select one or more images that can be included on the packaging of the compact disc.

In yet another embodiment, a method for determining dating compatibility of users of an online network based on music interests is provided. The method includes creating a first profile of a first user of the network, and creating a plurality of other profiles for a plurality of other users of the network. A selection of music that the first user would like to receive as a gift is identified, and a selection of music that each of the plurality of other users would like to receive as a gift is identified. A music preference of the first user is obtained by categorizing the selection of music identified by the first user into one or more of a plurality of genres of music, and a music preferences of the plurality of other users is obtained by categorizing the selection of music identified by each of the plurality of other users into one or more of a plurality of genres of music. The music preferences of the first user is compared to the music preferences of the plurality of other users to determine a musical compatibility between the first user and the plurality of other users. The musical compatibility is based at least in part on the similarity of the identified music based upon the genres into which the music has been categorized. The plurality of other users are sorted in order of a most compatible match to a least compatible match based on the determination of musical compatibility. The first user is provided with a list of potential matches, with the list including at least the most compatible match.

In another aspect, the selection of music identified by the first user and the plurality of other users comprises music albums. The music albums can be selected from a pre-selected collection of albums in an online database. In another aspect, the selection of music identified by the first user and the plurality of other users comprises individual music songs. The individual music songs can be selected from a pre-selected collection of songs in an online database.

The foregoing and other objects, features, and advantages of the invention will become more apparent from the following detailed description, which proceeds with reference to the accompanying figures.

### BRIEF DESCRIPTION OF THE DRAWINGS

FIG. 1 shows a schematic block diagram of an embodiment of an apparatus for providing a music-oriented dating and social networking system.

FIG. 2 illustrates a computer system usable with the system of FIG. 1.

FIG. 3 shows a flowchart of an embodiment of a method for providing an music-oriented dating and social networking system.

FIG. 4A shows a schematic of a computer display screen illustrating a process for selecting and identifying musical preference information of a user.

FIG. 4B shows a schematic of a computer display screen illustrating a process for selecting and identifying musical preference information of a user.

FIG. 4C shows a schematic of a computer display screen illustrating a process for selecting and identifying musical preference information of a user.

FIG. 5 shows a schematic of a computer display screen illustrating a process for selecting and identifying musical preference information of a user.

FIG. 6 is a flowchart illustrating a process for selecting and identifying musical preference information of a user.

### DETAILED DESCRIPTION

Described herein is a novel method and system for connecting and matching users in an electronic dating and social networking system. The novel method and system is described below.

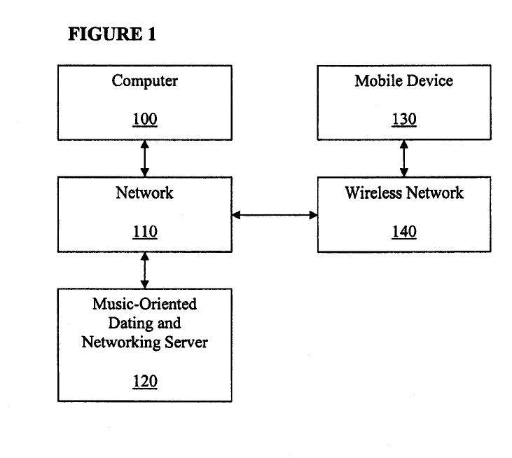

FIG. 1 shows one embodiment of a basic system associated with the novel electronic dating and social networking serve. As shown in FIG. 1, the system can include computer 100, network 110, server 120, mobile device 130, and wireless network 140. The computer 100 can be any computer system that is capable of sending and receiving messages and data to and from another computer device, including server 120. Similarly, mobile device 130 can be any kind of mobile device that is capable of sending and receiving messages and data to and from another computer device, including server 120. Computer 100 can be, for example, a personal computer, a laptop computer, or other type of computer device. Mobile device 130 can be, for example, a cell phone, a personal digital assistant (PDA), or other hand-held device.

Server 120 is a computer system that is designated for running the software required to perform the processes discussed in more detail below. Server 120 may consist of a single server computer or it may comprise multiple server computers. The information and data is transferred to and from computer 100 and server 120 via network 110. Network 110 can be any type of network capable of transferring electronic information and may include, for example, the Internet, local area network (LANs), wide area networks (WANs), or any combination of thereof. Mobile device 130 can transmit and receive information and data over a wireless network 140, which, in turn, can connect to network 110. The wireless network can be any known wireless network, including a cellular network.

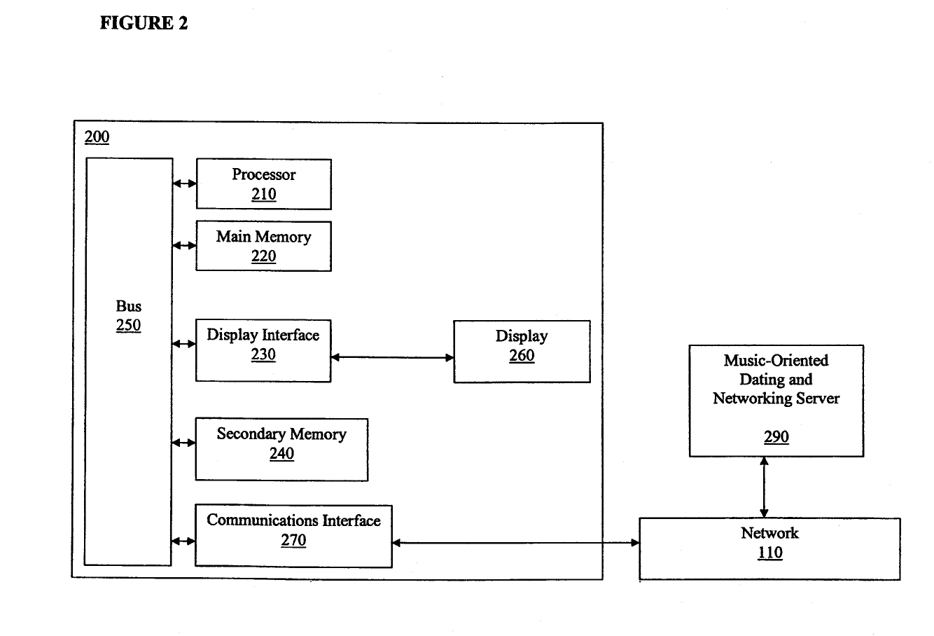

FIG. 2 shows a computer system 200 for interacting with network 110. Computer system 200 preferably includes one or more processors, such as processor 210. Processor 210 is connected to communication bus 250 (or other communication infrastructure) which permits it to communicate with other elements of computer system 200. Computer system 200 can include a display interface 230 that is capable of sending graphical, text, and other information to display 260.

Computer system can include main memory 220, preferably random access memory (RAM), and secondary memory 240. Secondary memory 240 can include, for example, a hard disk drive or a removable storage device. The secondary memory 240 can permit software or other instructions to be loaded into the computer system 200.

Computer system 200 can also include a communications interface 270 that allows software and data to be transferred between computer system 200 and external devices, including the server of the system (i.e., Music-oriented dating and networking server 290), which is also connected to network 110. The communication interface 270 can include a modem, a network card (e.g., Ethernet card), a communications port, a PCMCIA slot and card, etc.

The system described below can transmit data and information from the server 290 to computer system 200 so that the user can view this information on his or her display 260. Server 290 in turn can comprise one or more computer systems, such as computer system 200. Server 290 preferably has main memory or secondary memory that stores and operates computer programs capable of running the system discussed below. Such computer programs, when executed, enable the server's processor(s) to perform the steps described below.

Additional information and details concerning wireless networks and methods of communicating between computers, mobile devices, and servers can be found in United States Patent Publication No. 2006/0059160 A1 to Smola et al., which is incorporated by reference herein.

It should be understood that for each step described below, communication with server 120 can be achieved by inputting information into an input device associated with computer 100 and/or mobile device 130 (e.g., a keypad, a keyboard, or a mouse device). In addition, information received from server 120 can be viewed on a screen or other information display of computer 100 and/or mobile device 130.

### Establish User Account

FIG. 2 is a flow chart illustrating steps of an embodiment of the novel method and system. Step 300 involves establishing a user account profile. In this step, a user inputs basic information about him or herself in order to establish and activate an account with the novel system and network discussed in detail below. This information exchange, and the other information exchanges between user and server 290 as discussed herein, is preferably entered via an input device of computer system 200 and received via a display 260. The information is preferably sent over network 110 to and from server 290. Alternatively, this information could be entered into mobile device 130 which sends it through wireless network 140 and to network 110 and server 120, as shown in FIG. 1.

The information conveyed in Step 300 can include basic information such as name, physical address, email address (which preferably must be verified), telephone number, and birth date. After this information is entered, and the email address is verified, the user is provided with a user name and password. Preferably, the user is able to select his or her own username and password.

At this time or at a later time, the user can personalize his or her profile by including various information that is traditionally included on dating websites. For example, the user can indicate likes and dislikes in movies, food, entertainment, sports, books, etc.

### Collection of Music Preferences

After the basic information is acquired and a user account is established, the user's musical preferences can be collected (Step 310). The user can choose his or her favorite master genres of music from a pre-selected list of music genres that is generated on the user's display screen of the user's computer or mobile device. Preferably, these preselected genres are arranged in drop-down menus and/or can be manipulated and re-ordered in a drag-and-drop manner by a user to reflect his order of preference. The drop-down and re-ordering capabilities can be created using any of various computer scripting languages, such as AJAX scripting for PHP.

The master genres of music that are to be ranked by the user can vary; however, preferably there are at least 5 different genres to be ranked, and even more preferably at least 10 different genres. The user can manipulate the order of the master genres in his list by using the drag-and-drop system discussed above until the user feels the order of genres accurately reflects his or her order of preference for those music genres.

In addition to ranking the genres in order, the user can also identify genres that the user intensely dislikes. Thus, for example, if “Musicals” is one genre and the user strongly dislikes musicals, in addition to placing that genre last in the ranking order, the user can identify that genre as a “deal-breaker.” As discussed in more detail below, the identification of a genre as a “deal-breaker” will be treated differently when matching users. Preferably, the user can only identify two genres as being deal-breakers. If the user does not have any strong negative feelings about any particular genre, the user can simply select “not applicable” instead of identifying a genre as being a deal-breaker.

In order to more accurately gauge a user's music preferences, the user is requested to rank sub-genres for at least the first two highest ranked master genres. Preferably, the user will be requested to rank sub-genres for the five top master genres selected by the user. The number of sub-genres for each master genre can vary depending on the master genre. However, preferably the number of sub-genres is at least five, and more preferably the number of sub-genres is about ten. For example, if the master genre is “Rock,” the sub-genres can include: “Folk Rock,” “Hard Rock,” “Classic Rock,” “Blues Rock,” “Country Rock,” “Progressive Rock,” “Alt Rock,” “Jazz Rock,” “Christian Rock,” and “1950's Rock.” The user can rank each of these sub-genres in order or preference, or alternatively, select his or her top five sub-genres.

By the identification of a user's specific tastes regarding master genres and sub-genres, the system can identify the precise musical tastes and/or preferences of the user to match against similar tastes and/or preferences of other users to locate and identify a potential dating partner. For example, by ordering about five master genres, and then ordering about ten subgenres in each classification, a suitably distinct and reliable result should appear.

Although a user has selected a master genre as being one of his or her favorite genres, because sub-genres can vary quite a bit, the user can again be offered the opportunity to select one or more of these sub-genres as being a “deal-breaker.”

Instead of or in addition to the collection of music preferences by having a user rank genres, the user's music preferences can be collected by providing the system with access to the user's digital music collection. If the user has a digital music collection stored on, for example, a hard drive, the system can be provided with access to the location on the hard drive where the digital music is stored. The system can than analyze the user's digital music collection to determine the music preference of the user. Preferably, this access will only require the system to undergo a high level analysis of the user's digital music collection. That is, the system preferably only considers the file names in order to analyze the artists, albums, and songs that are stored on the digital medium.

The system can analyze the music on the user's digital storage medium and, to the extent the system recognizes the artists and albums stored therein, the user's digital music collection can be rated according to the most popular master genres and sub-genres. The categorization of user's digital musical collection can be based on a comparison with a database of music that has already categorized artists, songs, and/or albums into various genres and sub-genres of music. The pre-categorized database can be developed using criteria developed specifically for the system or, alternatively, the system can use existing music genre categorizations that have already been created by third-parties. In this manner, the system can determine the kinds of music that the user has elected to collect. Alternatively, the user can select certain subsets of his or her collection to identify to the system in order to indicate the types of music that the user believes he or she most identifies with.

### Identification of Preferred Music Gifts

The user's preferred music gifts can be determined in Step 320. In this step the user can designate certain albums and songs that he or she would like to receive as a gift. As discussed in detail below, these albums or songs can be given to a user as a gift by other users. In addition, the selection of these albums or songs can be used to further analyze and characterize the user's preference in music.

Based on the user's selection of master genres and sub-genres, the system calculates an identifier number for the user. The identifier number is a pre-determined numerical number that characterizes a particular master genre and/or sub-genre. This number is based primarily on the sub-genres selected by the user. For example, the sub-genre of Folk Rock (under the master genre of Rock) may be assigned a particular number. This number has been previously associated with a variety of music albums by the system.

The system then populates the screen with a predetermined list of albums that correspond to the identifier number and which, based on the user selected sub-genres, reflect albums that the user will likely be interested in hearing and/or purchasing. Preferably, there are more than 20 albums listed based on the identifier. More preferably, there are more than 50 albums listed. Even more preferably, there are more than 75 albums listed.

The user is then asked to select 10 or more albums that the user would like to receive as a gift. The user is informed that the selection of these 10 albums will be kept confidential and that no other users will be able to see the user's selections. Later, as discussed below, users on the system will be given the option of choosing to give a gift to other users of the albums on their confidential list. Such a gift, however, will be “blind” in that the other users will not know what albums they are giving to the other user.

The user can rank the albums he or she would like to receive as a gift in order from 1 to 10, with 1 being the album that they would like to receive most. The user can preferably move an input device, such as a mouse cursor, over the list of albums and when the cursor rests on the album, information about that album is displayed on the user's display screen in a pop-up style box. For example, the pop-up box can display information about the artist, including a description or review of the music contained on the album and a list of songs on the album. Even more preferably, the user is provided with hyperlinks to online locations where the user can navigate to in order and listen to music samples from the albums. Alternatively, or in addition to the selection of 10 albums, the user can select individual songs that he or she would like to receive as a gift.

Again, as noted above, neither the albums nor songs selected by the user for gifting purposes will be visible to other users on the network. In this manner, users can select albums and songs that they truly desire to own without being influenced by the social pressures of appearing to like “popular” or “cool” music.

In addition to (or instead of) the pre-populated list of albums, the user can search and browse for other albums or songs that the user would like to receive as a gift. By permitting a user to select albums or songs that have not been pre-populated according to the user's previously identified preferences, the system can obtain more accurate insight into the musical interests of the user. For example, if the user selected “Folk Rock” as his or her favorite sub-genre, but indicated that he or she would like to receive as a gift an album that is classified as “Soft Jazz,” such a selection may provide additional details about the preferences of the user and this information can be used to further characterize the music preference of the user.

### Collection of Dating Filtering Information

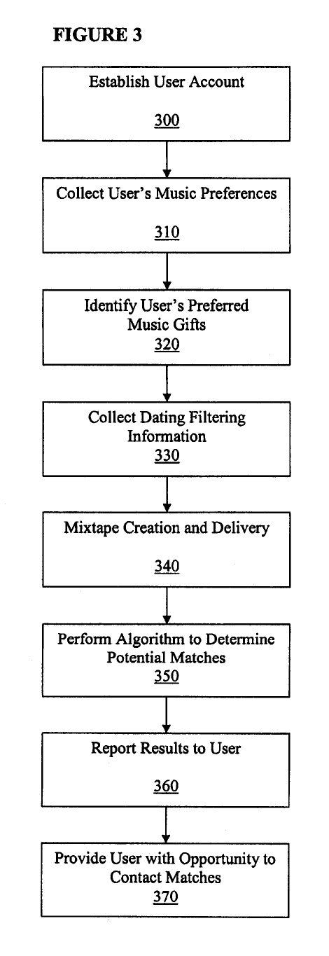

Referring again to FIG. 3, after the user's music preferences are collected in Steps 310 and 320, additional personal information can be collected in Step 330. It should be noted, however, that the order of the steps discussed herein and shown in FIG. 3 can vary. For example, Steps 300 and 330 can be combined into one step and all personal and dating information can be collected at Step 300 at the time the account is first established.

The additional personal information that can be collected in Step 330 may include basic dating information (i.e., non music-related information). At this time the sex of the user and the user's sexual preferences can be determined. The user can be asked, for example, “what is your sexual preference?” and asked to select one of the following categories in response to that question:
1. I am a female looking to meet a male.
2. I am a male looking to meet a female.
3. I am a male looking to meet a male.
4. I am a female looking to meet a female.

At this time the user also can be asked to disclose his or her age preferences. For example, the user can be instructed to select one or more of the following age ranges:
1. 18-25
2. 26-30
3. 31-35
4. 36-40
5. 41-45
6. 46-50
7. 50-55
8. 55 and older
   Alternatively, the user can select a specific age range by entering a low end of the range and a high end of a range.

A user may also indicate his or her regional preferences. For example, the user may be asked to select one or more of the following regional preferences:
1. Show me only those people who live in my State.
2. Show me only those people who live in my City.
3. Show me only those people who live in the following zip codes ______.
4. Show me anyone who matches my other requirements regardless of where they live.
   For number 3 above, the user can manually enter one or more zip codes into the system.

The user also can be prompted to provide and upload a current photograph. In addition, if desired, a person can be requested to provide a physical description of him or herself (e.g., height, hair color, eye color, etc.) as well as to provide his or her personal preferences in other people.

### Mixtape Creation and Delivery

Referring again to FIG. 3, Step 340 involves creating a “mixtape.” A mixtape is a compilation of songs recorded in a specific order, traditionally onto an audio cassette. With the advent of digitally recorded music, the audio cassette mixtape has generally been replaced by digital files stored on compact discs, hard drives, and other similar media. The mixtape usually reflects the musical tastes of its compiler or is designed to affect a particular mood or make a determined social statement in the dating environment. It can range from a casually selected list of favorite songs, to a conceptual mix of songs linked by a theme or mood, to a highly personal statement tailored to the mixtape's intended recipient. Users may carefully select and order the tracks in a mix, which becomes an artistic statement and more importantly, a presentation tool to show potential dates their creativity and artistic leanings in such a manner as to better promote themselves as a potential mate or dating partner.

At this point, the user is provided with a searchable and browseable collection of music from which the user can select songs to make a mixtape. The user can select songs for his or her mixtape. The songs are placed in a list and the user can change the order of the songs on the mixtape simply by dragging-and-dropping the songs in the list. The user can make as many mixtapes as the user would like. The user can either purchase these mixtapes for him or herself or give them as gifts to others. These mixtapes can be given as gifts to anyone, including those not on the network. Alternatively, as discussed below in more detail, they can be given as gifts to others on the network as a dating introduction and/or as an expression of dating interest or affection.

Each purchased mixtape can be deliverable in digital form, for example by downloadable MP3 formatted music files, or delivered to the user in the mail via a hard copy, such as a compact disc. If the user elects to have a hard copy of the music files mailed—either to him or herself, or to others—specific art may be ordered or created by the purchaser for the purpose of enhancing the presentation package.

### Perform Algorithm to Determine Potential Matches

Referring again to FIG. 3, Step 350 requires performance of an algorithm to determine potential matches for a user. After the user has entered the basic information and provided server 120 with his or her specific music preferences, the system analyzes the entered information and generates potential matches for the individual. The matching algorithm takes into consideration the dating filtering information from Step 330 above along with information obtained in Step 310.

The first aspect of the system's matching algorithm matches people based on whether they fall into each other's identified ranges and desired partnership requirements as set out in Step 330. For example, the system reviews the age, sex, and location of each user and determines whether the user's preferences in that regard are a match.

The second aspect of the system determines whether the individuals are a match musically. In this regard, the system takes into consideration the ranking of the master genres and sub-genres. Because of the greater population and number of users, people in large cities likely will have exact master genre matches, including either exact sub-genre matching or nearly exact sub-genre matches. The number of permutations for master genre and sub-genre should be enough to ensure good matches based on music preferences.

If parties list the same genre as their favorite, the matching is fine tuned by sub genres. If the parties both “like” the same genre—that is, if they have a same genre in their top half of their master genre selections—the parties are given a chance to introduce their mix tapes, cds, or song gifts as a way to make an introduction and bring them together musically speaking.

In addition, the system can further sort users based on whether their “deal-breakers” are compatible. That is, if one user selected “Musicals” as their favorite genre and another user identified “Musicals” as a “deal-breaker” a negative value or indicator would be associated with that indication that would make it less likely that the system would designate those two users as a match.

Users can be sorted by their final master genre list and matched according to that list. Assuming that there are ten master genres that may be sorted in order of preference, users are matched according to their master lists. If a perfect match is not found, the next perfect match is found and so forth.

Users who are matched by their most preferred master genre, are sorted by sub-genre selections and matched by those sub-genres. Users who otherwise are of the right age and location, are always provided with their top level matches in their region as sorted by sub genres. A precise match is preferred, but the next closest master and sub-genre matches can be sorted and provided.

Preferably, the algorithm also takes into consideration the albums or songs selected by a user as music they would like to receive as a gift. As discussed above, a list of albums or songs are presented to the user to be selected—not according to what they already possess—but according to what they want to be given as a gift. This selection process allows a greater validity in the overall accounting of the musical tastes of each user since users may socially identify with particular artists or songs but it is the songs they would purchase or wish to be given that provides a deeper understanding of the music they actually like. “Social distortion,” that is, identifying publicly with an artist due to peer pressure might otherwise cause a lack of validity of results regarding matching users with potential dating partners. By giving a blind system of music gifting as a part of the matching process, a higher validity is achieved.

Thus, the songs that are selected by the user to be received as a gift can be identified as belonging to one or more master and sub-genres, and those master and sub-genres of music can then be added as an additional factor in determining the user's music preferences. For example, this information can be used to confirm the selection of the user of his or her favorite genres in Step 310. Alternatively, it can be used as a separate marker to match the user with others.

The matching algorithm can be any suitable algorithm for comparing the matching factors, including master genre and sub-genre matching. For example, the Levenshtein distance metric can be used in one embodiment to measure the difference between profiles and determine music compatibility of two or more users.

In the following, two sample profiles (User1 and User2) are evaluated for Levenshtein distance. A setup table enables the administrator to determine weight of each parameter based on sampling size and website traffic. The algorithm can be based on a weighted matching system that gives varying weight to each of the different variables.

### EXAMPLE 1

| | | |
|---|---|---|
| Master Genre Ranking | Sub genre | Deal Breaker |

User #1

| | | |
|---|---|---|
| Rock | Hard rock | No Country |
| Rock | Jazz rock | |

User #2

| | | |
|---|---|---|
| Rock | Hard rock | No Country |
| Rock | Classic Rock | |

The data can be converted to data strings, such as User 1 data string=“hardrockjazzrocknocountry” and User 2 data string=“hardrockclassicrocknocountry”. This function returns the Levenshtein-Distance between the two argument user genre and sub genre selections or −1.

An example of an algorithm based on the data strings above is as follows:

// input user1
$input = “hardrockjazzrocknocountry” ’;
// array of genres to check against
$genre = array(Jazz, Classic Rock, Blues, Soul,
Gospel, Country, Classical, Rap/Hip Hop, Electronic,
Easy listening’);
$subgenre = array (Folk Rock, Hard Rock, Classic Rock
Blues Rock, Country Rock,Progressive Rock, Alt Rock,Jazz Rock,
Christian Rock, 1950's Rock)
// no shortest distance found, yet
$shortest = −1;
// loop through words to find the closest
foreach ($genres as $genre, $subgenre) {
// calculate the distance between the input genre,
// and the master genre
$lev = levenshtein($input, $genre, $subgenre);
// check for an exact match
if ($lev == 0) {
// closest genre, sub genre is this one (exact match)
$closest = $genre; $subgenre
$shortest = 0;
// break out of the loop; we've found an exact match
break;
}
// if this distance is less than the next found shortest
// distance, OR if a next shortest genre has not yet been found
if ($lev <= $shortest || $shortest < 0) {
// set the closest match, and shortest distance
$closest = $genre; $subgenre
$shortest = $lev;
}
}

The two users would be compared to each profile (or each profile that meets the basic dating requirements of the users). Each would have a Levenshtein-Distance value as how far they are from the profile.
User1 would be −3
User2 would be −2

Depending on the volume in the sample, a −1 to −5 in the rock category can be considered a potential match as determined by the setup table parameters. If there are more users of the system in a particular geographic location, it may be preferable to decrease the range of the Levenshtein-Distance value. Alternatively, if there are less users of the system in a particular geographic location, it may be preferable to increase the range of Levenshtein-Distance value.

### Reporting Results and Opportunity to Contact Potential Matches

Referring again to FIG. 3, in Step 360 the system outputs the results of the matching algorithm to the user. Once the system determines potential matches, the system outputs these potential matches to the user. Preferably, the user is provided with access to the profiles of the potential matches. The profiles can be provided to the user via email or the user can be provided with hyperlinks through which the user can access the profiles.

As shown in Step 370 of FIG. 3, the user is then invited to contact his or her potential matches. Contact can be made in one or more of the following ways. First, the user can send a private message to a potential match. This message can be an electronic message that is transmitted by the system to the potential match. This electronic message is preferably sent to the potential matches intra-system and not directly to the potential match's e-mail address. In this way, the user will not have access to a potential match's e-mail address or other contact information unless the potential match provides this information to the user.

Second, the user can send a mixtape to the potential match. Since the user has already been determined to be a musical match with the potential match, a mixtape created by the user is likely to be well received as a gift since both the sender and the receiver share similar interests in music. In other words, based on the matching algorithm, the potential matches will likely be predisposed to enjoying the same kinds of music as the user and therefore, the user can be relatively confident that potential matches will like the mixtapes created by the user.

The mixtape can be one that the user previously created or the user can create a custom mixtape specific to the potential match. The user also can decide whether or not he or she would like to purchase or create a special design for the cover of the mixtape. If the user elects this format, the potential match would have to receive the mixtape in the mail. Of course, the user would not know the potential match's address—the mixtape would be sent directly from the system or a third party provider.

Third, the user can elect to send a gift of an album or song to the potential match. This gift can be of an album or song that the user enjoys. Alternatively, the user can elect to give a gift of one of the albums or songs self-selected by the potential match. In this case, the user would not know what album or song was being given to the potential match. Just as with registry gift-giving, giving a gift that has been previously selected by the potential match ensures that the user is giving a gift that the receiver of the gift actually wants. Moreover, it can provide a great conversation starter for the two people to talk about in their first interaction.

If the user elects to send a gift of a mixtape or the potential match's previously-selected albums or songs, the potential match can accept or refuse the gift. If the potential match accepts the gift, the potential match may be given a choice to receive the gift by download or mail. If the potential match accepts the gift, the potential match can be encouraged by the system to send a thank you message to the user.

Because there will likely be less users in small towns, there may be fewer matches of master genres and sub-genres. In this instance, the system may rank potential matches according to the dating preferences discussed above as well as all other matching parameters discussed herein. In addition, the opportunity to create and deliver mixtapes and album gifts, as discussed above, may convert other users to music genres they have not been exposed to and, in doing so, produce a suitable dating relationship.

The following examples illustrate the use of the above matching algorithm:

### EXAMPLE 2

1. User enrolls and identifies herself as:
Female
Seeking Male
Her age, 25
Target Age 18-40
Zip Code Preferences: None
Regional Preference: Portland, Oreg.

2. Her Ranked Master Genre Selections:
Jazz
Classic Rock
Blues
Soul
Gospel
Country
Classical
Rap/Hip Hop
Electronic
Easy listening

3. She is then asked to sort her preferences for her number one master genre selection which is “Jazz’ by sub genres. She sorts them as follows:
Acid jazz
Asian American jazz
Avant-garde jazz
Bebop
Big band
Crossover jazz
Dixieland
Calypso jazz
Chamber jazz
Cool jazz
Free jazz
Gypsy jazz
Hard bop
Jazz blues
Jazz-funk
Jazz fusion
Jazz rap
Latin jazz
Mainstream jazz
Mini-jazz
Modal jazz
M-Base
Nu jazz
Smooth jazz
Soul jazz
Swing
Trad jazz
West Coast jazz

The system then seeks to find:
A) A male, in the proper age range, in the proper city; and
B) Who has listed Jazz as his first choice.

The system locates 350 men in Portland who prefer Jazz and are of the correct age and location. The system then seeks to find which of those 350 men have the same precise master genre list in the same order of preference. Those who have the same master genre list are selected. Ten men are found with the exact sub master listing in Jazz.

The system outputs to the female the 10 men with the exact sub-genre listing in Jazz, and provides the female with the option to see additional, less-perfect matches (e.g., from the 240 men who did not qualify as an exact match. The system can further analyze the 240 men to sort them according to those that have closer matches to the female in their sub-genres.

In addition, after the initial sorting above, the system also can sort users based on whether their second, third, fourth, or fifth master genres are a match. The identification of deal-breakers by one user can also be used at this point to further sort the compatibility of users. For example, if User 1 listed Jazz as his favorite master genre and Musicals as his second favorite genre; User 2 listed Jazz as her favorite master genre and Musicals as a deal-breaker; and User 3 listed Jazz as her favorite genre and Musicals as her seventh favorite genre, but not as a deal-breaker; then the system would rank User 3 above User 2 when attempting to find a potential match for User 1.

Alternatively, the system can take into consideration the matching consequences of people who have selected the same genres as deal-breakers. That is, two people who have indicated that “Musicals” are a deal-breaker can be ranked as being a better match than two people who have identified different genres as deal-breakers.

### EXAMPLE 3

Male, seeks female, any age range, in Lake Havasu City, Ariz. His master genre lists Jazz as his first choice. He is matched against females in Lake Havasu City.

There are only 15 females on the network in Lake Havasu City and no top level genre is matched. That is, the first listed master genre of the Male does not match with the first listed genre of any of the 15 females in Lake Havasu City. Accordingly, the system will consider whether there is a second level master genre match. The second level match considers whether any female user has identified in their top two master genres any genres in Male's top two master genres. This process preferably continues through the first half of all the master genres, and more preferably through all of the genres to rank the females according to the closest match to Male. For example, those females who have listed Jazz at least in their top half of their master genres will be identified to Male as closer matches than those who have not listed Jazz in the top half of their master genres.

In addition, the system can consider deal-breakers as discussed above with Example 1.

### Dating Card or Musical DNA

To further identify a user's music interests a user can self-select a certain number of songs. These songs can appear on his or her main profile page so they are visible to other users or, if not on the main page, they can be accessed by other users. This “dating card” of songs can reflect what the user believes is his or her musical “DNA.” The user preferably selects at least 10 songs, or more preferably more than 15 songs that appear along with his or her profile. Other users can download and/or stream these songs and play them while viewing the user's profile page. In this manner, users can experience and listen to music that a particular user has identified as being of importance to him or her. In addition, the user can preferably rank the selected songs in order of his or her favorites. Thus, by viewing the music on a user's Dating Card (i.e., the songlist), users can immediately see the songs that are currently most important to the user.

User's can preferably vary and modify their dating card at any time. The songs selected for the user's dating card can be selected from the system's database or catalogue of songs. Alternatively, the user can upload his or her own music to include on his or her dating card. The music is preferably required to select the songs from albums that reflect the sub-genres of music that the individual has selected as being his or her favorite sub-genres. Alternatively, the music can be selected from any genre.

### EXAMPLE 4

The following example shows how the system can be used to obtain information about user's musical preferences in a musical interview process. The first step involves having the user select the user's top five (i.e., favorite) music genres. Using drag and drop technology, the user can select five genres and rate those genres from most favorite to fifth-most favorite. The resulting ranking can return an identifying number or code based upon the ranking of the top genres and used by the matching system to match or eliminate matches by the users selecting. The genres and sub-genres identified in this example are simply for illustrative purposes.

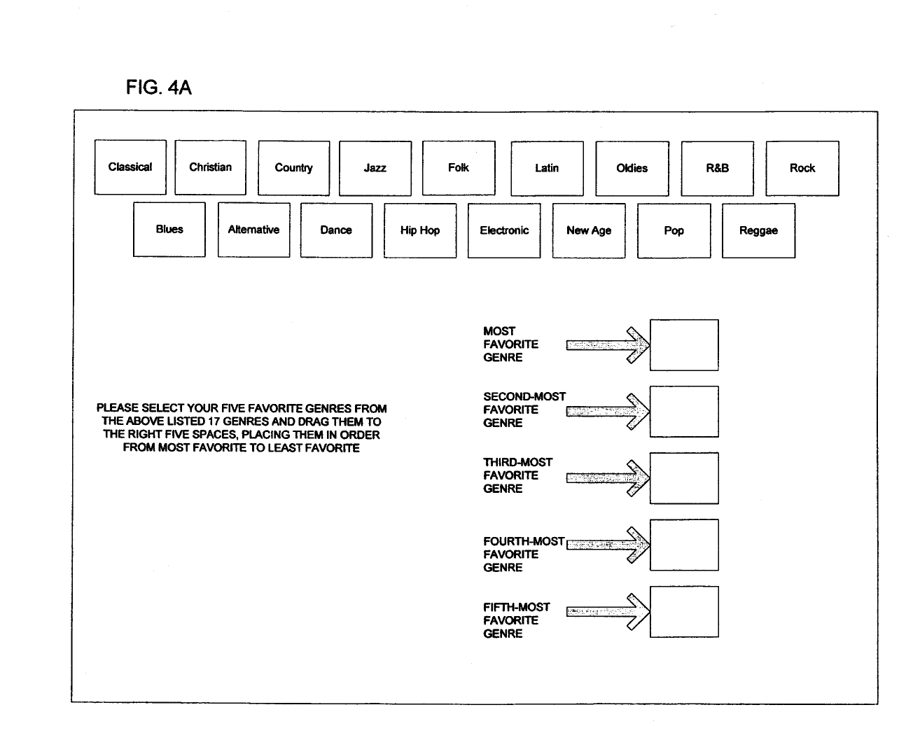

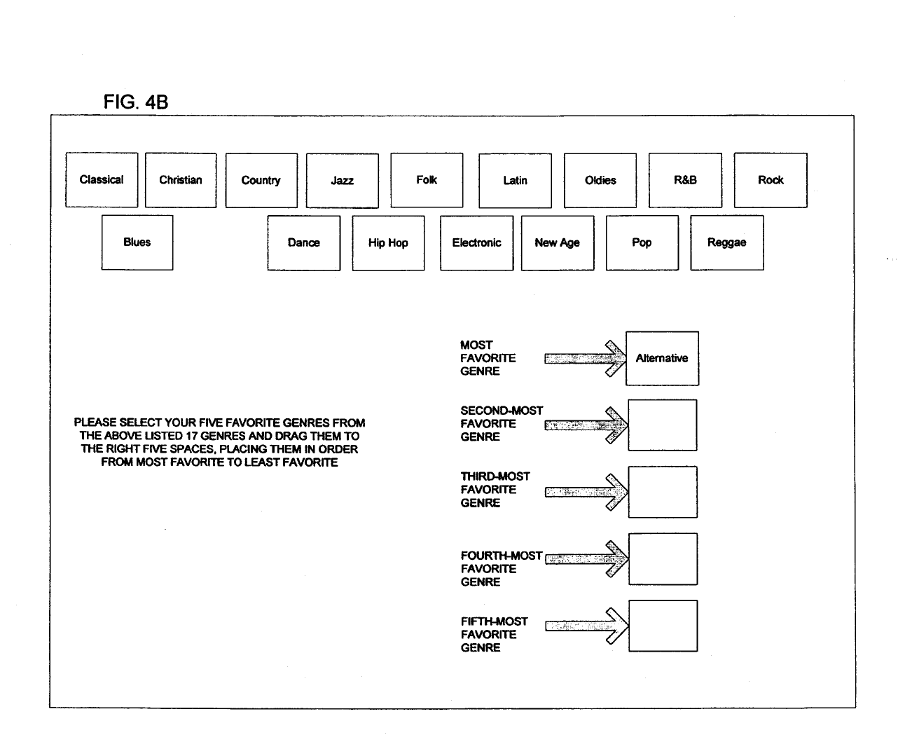

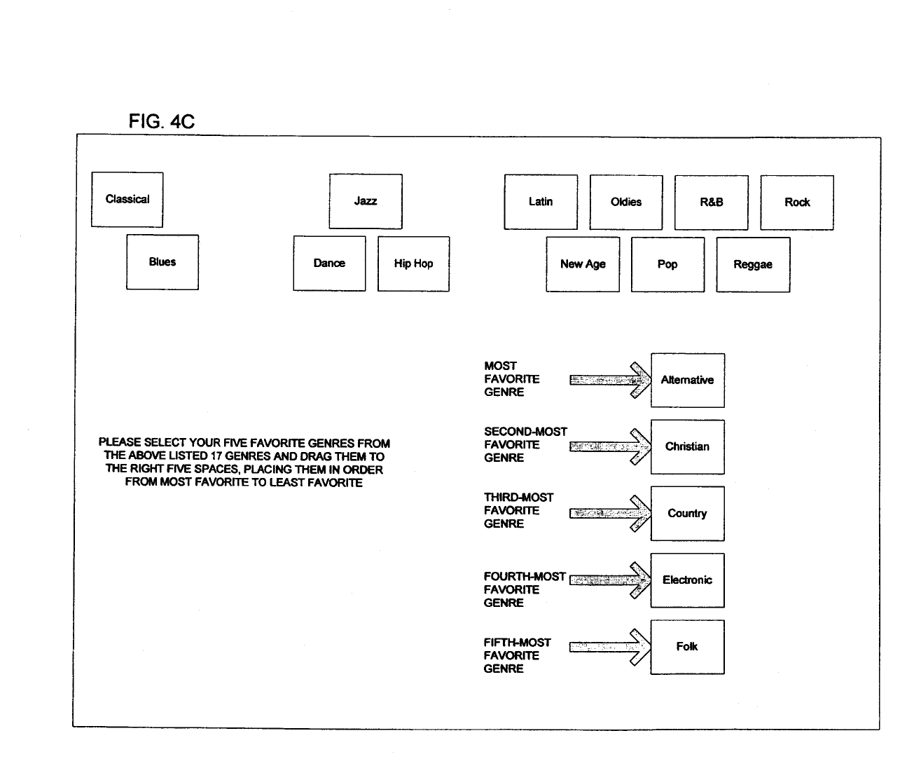

FIGS. 4A-4C show example computer screen displays associated with the user's selection of genres. FIG. 4A shows 17 possible genres from which the user is prompted to select his or her favorite five genres, ordering them in his or her preference from most favorite to least favorite. FIG. 4B shows another screen display where the user has begun the selection process by dragging and dropping the genre box “Alternative” into the area designated for the “Most Favorite Genre.” FIG. 4C is another screen display which shows a display where the user has identified and dragged his or her five favorite genres into the designated areas on the bottom right hand side of the display. The user can manipulate the location of the genre blocks on the screen until the user is satisfied that the order of the genres reflects his or her order of preference for those genres.

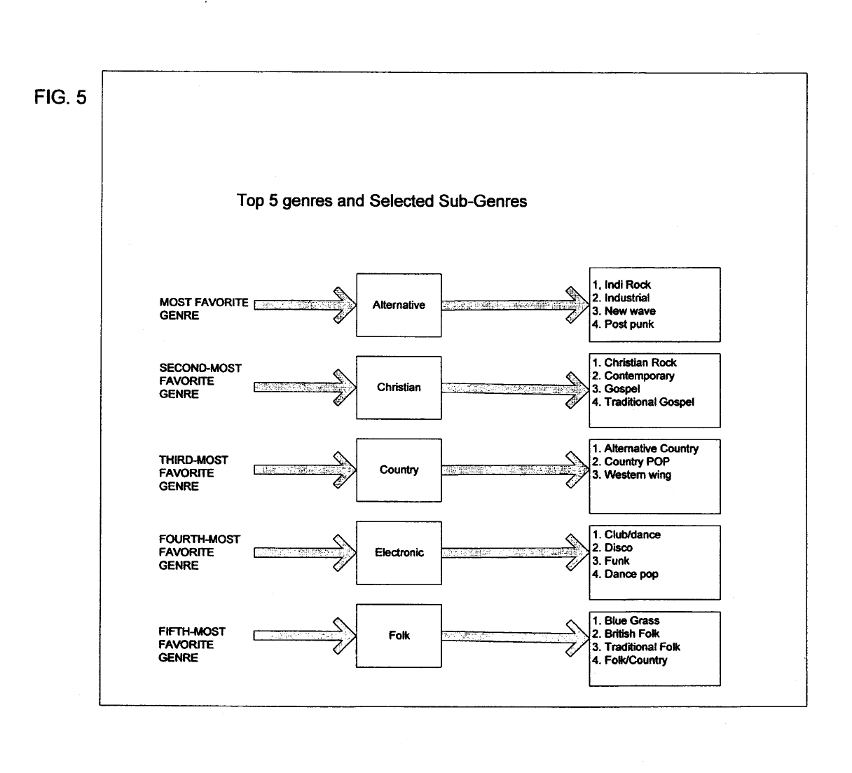

The second step involves selecting sub-genres for each of the five favorite music genres. After the user drags and drops his or her favorite genres into a specified location, the system then presents the users top five genres and the user can select his or her favorite sub-genres (desirably by dragging and dropping in the manner discussed above. The process can be similar to that described above for the selection of genres (e.g., dragging and dropping sub-genre boxes on a screen display). FIG. 5 reflects a screen display where the user has selected five favorite genres along with various numbers of sub-genres and the screen display shows those selections. Of course, the display could be configured so that the user can select these genres and/or sub-genres (and the system can display them) in a variety of ways.

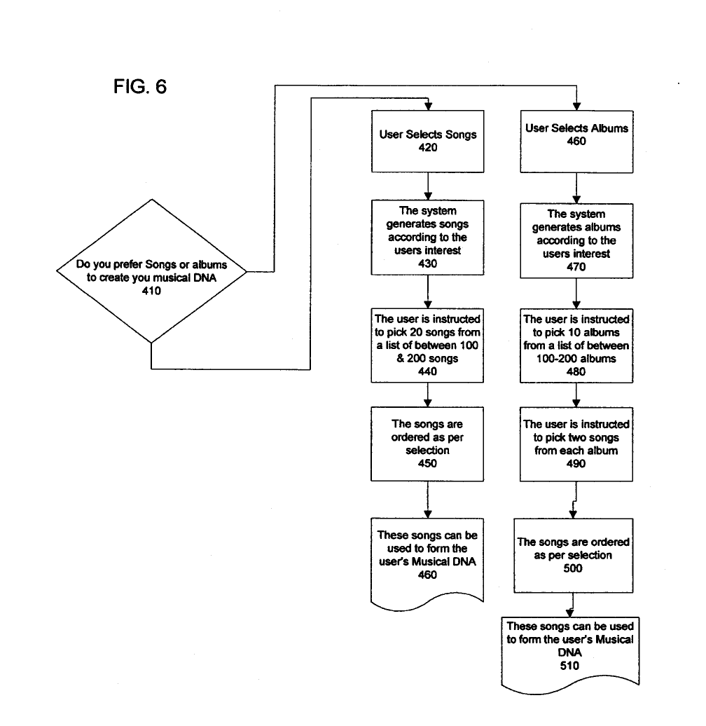

The third step involves offering the user a choice of selecting albums or songs in each sub-genre in order to create a Musical DNA Card. FIG. 6 shows a flowchart that sets out certain steps in the process of creating a DNA card. First, the user can be prompted to indicate whether he or she would like to create a musical DNA by selecting songs or albums (Step 410). If the user selects songs (Step 420), the system can generate a variety of song choices for the user based on the users interests (i.e., genre and sub-genre selection) in Step 430. The user is instructed to choice a number of songs from the generated list of songs in Step 440. The number of songs can be between 100 and 200 and the user can be requested to select between 10 and 30, and desirably about 20 songs. The songs can be ordered by the user to show his or her favorites among the songs selected (Step 450). In Step 460, the user's selection of songs can be used to arrive at the Musical DNA Card of the user.

If the user selects albums (Step 460), the system can generate a number of albums that the user can choose between (Step 470) based on the user's musical interests. The user can be instructed to choose a number of albums from the generated list of albums (Step 480). The number of albums can be between 100 and 200 and the number of albums that the user must select can be between 5 and 20, and desirably about 10 albums. The user can then be requested to pick his or her favorite song(s) from each album, desirably about two songs per album (Step 490). The songs can be ordered by the user to show his or her favorites among the songs selected (Step 500). In Step 510, the user's selection of songs can be used to arrive at the Musical DNA Card of the user.

### Value Match Score

As discussed above in Example 2, the system can sort users based on how closely the master genres and sub-genres match up. Preferably, the system sorts and ranks the closeness of the match and determines an objective measure or “value” score for the matches. This value score is preferably presented to the user to inform the user of the closeness of the match between his or her music preference and the music preference of the potential match. For example, a user can be presented with a list of potential matches that are ranked on a percentage scale according to the strength of the match. In one instance, for example, a user may be presented with his or her top match along with an indication that the top match is a 98% match to the user. The next top match presented to the user may be, for example, only a 78% match. In this manner, the user will be informed that potential match number 1 is much more closely matched than potential match number 2. This will let the user know how closely the potential matches' music preferences align with the user's music preference so that the user can make an informed decision as to whether or not the user would like to contact the identified potential matches.

The ranking or sorting of potential matches can be done in numerous ways other than a numerical ranking system based on percentages. For example, the system can rank potential matches on levels, such as from Level 1 through Level 5, or from A ranking to F ranking, or color shades from Red to Pink, etc.

In addition, along with a value scoring indication, the system can also output to users a chart or other summary showing the similarities of music preferences between the user and the potential match. In some instances, a particular user may be more interested in whether his or her interests in a particular sub-genre are aligned and less concerned with whether the potential matches second, third, or fourth master genres are aligned with the user. In this instance the user can review the summary provided with the list of potential matches in order to more accurately locate the appropriate match for the user from his or her list of potential matches.

Independent Musicians

Independent musicians who join as users (members) have the option to upload their own music files. These files can be uploaded to the server in a digital format (e.g., MP3 files). The independent musicians can either designate their music as free and users of the system can obtain and distribute the free songs uploaded by the musician. Alternatively, independent musicians can list their music as being available for cost. The music uploaded by independent musicians can be included in mixtapes and/or sold in the same manner as the music discussed above. Thus, independent musicians can provide gifts of their own music to potential matches.

In addition to creating music mixtapes, independent musicians can create and send their own video montages to other users of the system. These video montages may be music videos or otherwise music related. However, they can also be non-music oriented. Of course, other non-musicians could also create their own video montages—music or non-music oriented—and these montages could be sent as gifts or introductions to other users of the system.

In view of the many possible embodiments to which the principles of the disclosed invention may be applied, it should be recognized that the illustrated embodiments are only preferred examples of the invention and should not be taken as limiting the scope of the invention. Rather, the scope of the invention is defined by the following claims. We therefore claim as our invention all that comes within the scope and spirit of these claims.

We claim:

1. A method for determining dating compatibility of users of an online system based on music interests, comprising the steps of:
creating a first profile of a first user of the online system;
creating a plurality of other profiles for a plurality of other users of the online system;
obtaining a music preference of the first user by ranking at least five different genres of music according to the desirability of those genres of music to the first user;
obtaining the music preferences of the plurality of other users by ranking the at least five different genres of music according to the desirability of those genres of music to each of the plurality of other users;
comparing the music preferences of the first user to the music preferences of the plurality of other users to determine a musical compatibility between the first user and the plurality of other users, the musical compatibility being based on the similarity of the rankings of the at least five different genres of music;
sorting the plurality of other users in order of a most compatible match to a least compatible match; and
providing the first user with a list of potential matches, the list including at least the most compatible match.

2. The method of claim 1, wherein the music preference of the first user and the music preferences of the plurality of other users are obtained by ranking at least ten different genres of music according to the desirability of those genres of music to each user.

3. The method of claim 1, wherein the steps of obtaining the music preference of the first user and obtaining the music preferences of the plurality of other users further comprises:
presenting the first user with a list of genres to be ranked, the list including the at least five different genres of music; and
presenting the plurality of other users with the list of genres to be ranked.

4. The method of claim 3, wherein the steps of obtaining the music preference of the first user and obtaining the music preferences of the plurality of other users further comprises:
permitting the first user and the plurality of other users to rank the genres in the list by dragging-and-dropping the genres on a display screen until the order of the list reflects the order of desirability of those genres to the first user and each of the plurality of users.

5. The method of claim 1, wherein the steps of obtaining a music preference of the first user and obtaining the music preferences of the plurality of other users further comprises:
analyzing a digital music collection of the first user and each of the plurality of other users, the digital music collections being stored on digital storage mediums;
categorizing at least some of the music contained in each of the digital music collections into the at least five different genres of music;
determining the music preference of the first user by ranking the at least five different genres of music in order of a most highly represented genre in the first user's digital music collection to a least highly represented genre in the first user's digital music collection based on the categorizing step; and
determining the music preference of the plurality of other users by ranking the at least five different genres of music in order of a most highly represented genre in each of the plurality of other users' digital music collection to a least highly represented genre in each of the plurality of other users' digital music collection based on the categorizing step for each of the plurality of other users.

6. The method of claim 1, further comprising the steps of:
identifying the highest ranked genre of music by the first user and each of the plurality of other users;
creating a list of at least five sub-genres for the highest ranked genre of music, the sub-genres being types of music that are encompassed by the highest ranked genre of music;
obtaining a sub-genre music preference of the first user by ranking the at least five different sub-genres according to the desirability of those sub-genres to the first user;
obtaining a sub-genre music preference of the plurality of other users by ranking the at least five different sub-genres according to the desirability of those sub-genres to each of the plurality of other users;
further comparing the music preferences of the first user to the music preferences of the plurality of other users based on the rankings of the at least five different sub-genres of music to further determine the musical compatibility between the first user and the plurality of other users; and
further sorting the plurality of other users in order of a most compatible match to a least compatible match based on the further comparing step.

7. The method of claim 1, further comprising the steps of:
obtaining at least one deal-breaking genre of the first user, the deal-breaking genre being one of the at least five different genres of music, the deal-breaking genre being identified by the first user to reflect a subjective dislike for that particular genre of music;
comparing the deal-breaking genre of the first user to the music preferences of the plurality of other users; and
reducing the musical compatibility of the first user to each of the plurality of other users that ranked the deal-breaking genre in their top two most desirably genres.

8. The method of claim 1, further comprising the steps of:
obtaining dating filtering information of the first user and the plurality of other users, the dating filtering information including the sex, age, and geographic location of the first user and each of the plurality of other users; and
further sorting the plurality of other users in order of a most compatible match to a least compatible match based on the dating filtering information.

9. The method of claim 1, further comprising the step of:
providing the first user with access to the profiles of the potential matches.

10. The method of claim 9, wherein the provision of access to the profiles of the potential matches includes providing the first user with hyperlinks that direct the first user to the profiles of the potential matches.

11. The method of claim 9, further comprising the step of:
providing the first user with the ability to send an electronic message to each of the potential matches.

12. The method of claim 9, further comprising the step of:
providing the first user with the ability to send a gift of music to each of the potential matches.

13. The method of claim 12, wherein the gift comprises a mixtape, the mixtape being a compilation of songs selected by the first user, with the sequence of the songs being selected by the first user.

14. The method of claim 13, wherein the mixtape can be sent to the other users identified on the listing as one or more downloadable, digital files.

15. The method of claim 13, wherein the mixtape can be sent to the other users identified on the listing via the mail as a compact disc.

16. The method of claim 15, wherein the first user can select one or more images that can be included on the packaging of the compact disc.

17. The method of claim 12, wherein the gift comprises a pre-selected album or song, the pre-selected album or song having been pre-selected by the potential match and being unknown to the first user.

18. The method of claim 17, wherein the identity of the pre-selected album or song is taken into consideration in determining the musical compatibility between the first user and the potential match.

19. A method for determining dating compatibility of users of an online system based on music interests, comprising the steps of:
obtaining a music preference of a first user by ranking at least five different genres of music according to the desirability of those genres of music to the first user;
obtaining the music preferences of a plurality of other users by ranking the at least five different genres of music according to the desirability of those genres of music to each of the plurality of other users;
comparing the music preferences of the first user to the music preferences of the plurality of other users to determine a musical compatibility between the first user and the plurality of other users, the musical compatibility being based on the similarity of the rankings of the at least five different genres of music;
sorting the plurality of other users in order of a most compatible match to a least compatible match;
sending the first user a list of potential matches, the list including at least the most compatible match; and
providing the first user with the option of sending a mixtape to one or more of the potential matches identified in the list, the mixtape being a compilation of songs presented in a specific order.

20. The method of claim 19, wherein the mixtape can be sent to the other users identified on the listing as one or more downloadable, digital files.

21. The method of claim 19, wherein the mixtape can be sent to the other users identified on the listing via the mail as a compact disc.

22. The method of claim 21, wherein the first user can select one or more images that can be included on the packaging of the compact disc.

23. A method for determining dating compatibility of users of an online system based on music interests, comprising the steps of:
creating a first profile of a first user of the online system;
creating a plurality of other profiles for a plurality of other users of the online system;
identifying a selection of music that the first user would like to receive as a gift;
identifying a selection of music that each of the plurality of other users would like to receive as a gift;
obtaining a music preference of the first user by categorizing the selection of music identified by the first user into one or more of a plurality of genres of music;
obtaining a music preferences of the plurality of other users by categorizing the selection of music identified by each of the plurality of other users into one or more of a plurality of genres of music;
comparing the music preferences of the first user to the music preferences of the plurality of other users to determine a musical compatibility between the first user and the plurality of other users, the musical compatibility being based at least in part on the similarity of the identified music based upon the genres into which the music has been categorized;
sorting the plurality of other users in order of a most compatible match to a least compatible match based on the determination of musical compatibility; and
providing the first user with a list of potential matches, the list including at least the most compatible match.

24. The method of claim 23, wherein the selection of music identified by the first user and the plurality of other users comprises music albums.

25. The method of claim 24, wherein the music albums are selected from a pre-selected collection of albums in an online database.

26. The method of claim 23, wherein the selection of music identified by the first user and the plurality of other users comprises individual music songs.

27. The method of claim 24, wherein the individual music songs are selected from a pre-selected collection of songs in an online database.
